(19) United States
(12) Patent Application Publication
(10) Pub. No.: US 2025/0330831 A1
(43) Pub. Date: Oct. 23, 2025

(54) PERCEPTION ASSISTED BEAM MANAGEMENT FOR WIRELESS COMMUNICATION WITH VEHICLES

(71) Applicant: QUALCOMM Incorporated, San Diego, CA (US)

(72) Inventors: Himaja KESAVAREDDIGARI, Bridgewater, NJ (US); Mahmoud ASHOUR, San Diego, CA (US); Kapil GULATI, Belle Mead, NJ (US); Hong CHENG, Basking Ridge, NJ (US); Gene Wesley MARSH, San Diego, CA (US); Shailesh PATIL, San Diego, CA (US)

(21) Appl. No.: 19/090,016

(22) Filed: Mar. 25, 2025

Related U.S. Application Data
(60) Provisional application No. 63/637,268, filed on Apr. 22, 2024.

(51) Int. Cl. H04W 16/28; H04B 17/318; H04L 5/00; H04W 56/00

(52) U.S. Cl. CPC H04W 16/28; H04B 17/328; H04L 5/0051; H04W 56/0015

(57) ABSTRACT

Methods, systems, and devices for wireless communications are described. A user equipment (UE) may obtain a set of transmit beams associated with a network entity, where a set of candidate receive beams associated with the UE correspond to the set of transmit beams. The UE may obtain from one or more sensors associated with the UE, perception information indicative of an expected environment of the UE, where the perception information may include mobility information, spatial information, and additional information associated with the UE. The UE may select, in accordance with the perception information and the expected environment of the UE, a receive beam to measure a strength of reference signals transmitted by each transmit beam of the set of transmit beams. As such, the UE may receive one or more reference signals and related signals from the set of transmit beams via one or more of the selected receive beams.

### CROSS REFERENCES

This Patent Application claims the benefit of U.S. Provisional Patent Application No. 63/637,268 by KESAVAREDDIGARI et al., entitled “PERCEPTION ASSISTED BEAM MANAGEMENT FOR WIRELESS COMMUNICATION WITH VEHICLES,” filed Apr. 22, 2024, assigned to the assignee hereof, and expressly incorporated herein.

### FIELD OF TECHNOLOGY

The following relates to wireless communications, including perception assisted beam management for wireless communication vehicles.

### BACKGROUND

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

One innovative aspect of the present disclosure can be implemented in a user equipment (UE). The UE includes one or more memories storing processor-executable code and one or more processors coupled with the one or more memories. The one or more processors may individually or collectively be operable to execute the code to cause the UE to obtain a set of multiple transmit beams associated with a network entity, where a set of multiple candidate receive beams associated with the UE correspond to the set of multiple transmit beams, obtain, from one or more sensors associated with the UE, perception information indicative of an expected environment of the UE, where the perception information includes mobility information, spatial information, and additional information associated with the UE, select, in accordance with the perception information and the expected environment of the UE, a receive beam from the set of multiple candidate receive beams to measure a strength of reference signals transmitted by each transmit beam of the set of multiple transmit beams, and receive one or more reference signals and related signals from the set of multiple transmit beams via one or more of the selected receive beams.

Another innovative aspect of the subject matter described in this disclosure can be implemented in a method for wireless communication by a UE. The method may include obtaining a set of multiple transmit beams associated with a network entity, where a set of multiple candidate receive beams associated with the UE correspond to the set of multiple transmit beams, obtaining, from one or more sensors associated with the UE, perception information indicative of an expected environment of the UE, where the perception information includes mobility information, spatial information, and additional information associated with the UE, selecting, in accordance with the perception information and the expected environment of the UE, a receive beam from the set of multiple candidate receive beams to measure a strength of reference signals transmitted by each transmit beam of the set of multiple transmit beams, and receiving one or more reference signals and related signals from the set of multiple transmit beams via one or more of the selected receive beams.

Another innovative aspect of the subject matter described in this disclosure can be implemented in a UE. The UE may include means for obtaining a set of multiple transmit beams associated with a network entity, where a set of multiple candidate receive beams associated with the UE correspond to the set of multiple transmit beams, means for obtaining, from one or more sensors associated with the UE, perception information indicative of an expected environment of the UE, where the perception information includes mobility information, spatial information, and additional information associated with the UE, means for selecting, in accordance with the perception information and the expected environment of the UE, a receive beam from the set of multiple candidate receive beams to measure a strength of reference signals transmitted by each transmit beam of the set of multiple transmit beams, and means for receiving one or more reference signals and related signals from the set of multiple transmit beams via one or more of the selected receive beams.

Another innovative aspect of the subject matter described in this disclosure can be implemented in a non-transitory computer-readable medium storing code for wireless communications. The code may include instructions executable by one or more processors to obtain a set of multiple transmit beams associated with a network entity, where a set of multiple candidate receive beams associated with the UE correspond to the set of multiple transmit beams, obtain, from one or more sensors associated with the UE, perception information indicative of an expected environment of the UE, where the perception information includes mobility information, spatial information, and additional information associated with the UE, select, in accordance with the perception information and the expected environment of the UE, a receive beam from the set of multiple candidate receive beams to measure a strength of reference signals transmitted by each transmit beam of the set of multiple transmit beams, and receive one or more reference signals and related signals from the set of multiple transmit beams via one or more of the selected receive beams.

Some examples of the method, UEs, and non-transitory computer-readable medium described herein may further include operations, features, means, or instructions for obtaining, over one or more durations, one or more camera images associated with a set of multiple camera imaging instances and one or more inertial measurement unit (IMU) logs associated with a set of multiple IMU logging instances, the perception information including the one or more camera images and the one or more IMU logs.

Some examples of the method, UEs, and non-transitory computer-readable medium described herein may further include operations, features, means, or instructions for generating one or more pluralities of predicted camera images indicative of the expected environment of the UE in accordance with the one or more camera images and the one or more IMU logs.

In some examples of the method, UEs, and non-transitory computer-readable medium described herein, each camera image of the one or more camera images includes a depth map and a color model associated with a spatial environment of the UE and each IMU log of the one or more IMU logs includes inertial information of the UE relative to the spatial environment of the UE, the inertial information including one or more of a speed of the UE, spatial directionality of the UE, an angular velocity of the UE, or a combination thereof.

Some examples of the method, UEs, and non-transitory computer-readable medium described herein may further include operations, features, means, or instructions for measuring a received strength of a first set of multiple synchronization signal blocks (SSBs) associated with the set of multiple transmit beams for generation of a first measurement database at a first synchronization signal burst set (SSBS) instance, where reception of the first set of multiple SSBs may be associated with one of a set of multiple SSBS instances and generating a first set of multiple spatial feature maps associated with the set of multiple candidate receive beams in accordance with the first measurement database, the perception information, and a first set of multiple predicted images generated for the first SSBS instance.

In some examples of the method, UEs, and non-transitory computer-readable medium described herein, each spatial feature map of the first set of multiple spatial feature maps may be a mapping of predicted beam strength values for each of the set of multiple candidate receive beams for spatial points associated with a spatial environment of the UE.

Some examples of the method, UEs, and non-transitory computer-readable medium described herein may further include operations, features, means, or instructions for generating a second set of multiple spatial feature maps associated with the set of multiple candidate receive beams in accordance with the first measurement database, the perception information, a first set of multiple predicted camera images, and a second set of multiple predicted camera images associated with the expected environment of the UE at a future SSBS instance and generating a combined spatial feature map in accordance with the first set of multiple spatial feature maps and the second set of multiple spatial feature maps, the combined spatial feature map corresponding to the expected environment of the UE and resulting changes in predicted beam strength values for the set of multiple candidate receive beams.

Some examples of the method, UEs, and non-transitory computer-readable medium described herein may further include operations, features, means, or instructions for transmitting, to the network entity, a UE status indication that includes one or more of a spatial target area, a velocity of the UE, a memory and computational capacity of a computer of the UE, and capability information associated with the one or more sensors.

Some examples of the method, UEs, and non-transitory computer-readable medium described herein may further include operations, features, means, or instructions for receiving, from the network entity, a network entity status indication and one or more operational parameters, the network entity status indication including an indication of a quantity of SSBs associated with the set of multiple transmit beams and a periodicity of a SSBS, the one or more operational parameters including one or more of sensor settings for the one or more sensors associated with the UE and one or more parameters for one or more algorithms at the UE.

Some examples of the method, UEs, and non-transitory computer-readable medium described herein may further include operations, features, means, or instructions for transmitting, to the network entity in accordance with receiving a first indication to transmit an experience replay, the first indication included in the network entity status indication or in the one or more operational parameters, the experience replay including one or more portions of information used by the UE in the selection of the receive beam for each transmit beam of the set of multiple transmit beams, the one or more portions of information including one or more of the perception information, a status of the expected environment, one or more algorithmic outputs of the one or more algorithms designated for beam management using the perception information, or a combination thereof.

In some examples of the method, UEs, and non-transitory computer-readable medium described herein, the selection, in accordance with the perception information, of the receive beam for measuring the strength of reference signal of each transmit beam of the set of multiple transmit beams may be in accordance with a machine learning algorithm or a non-machine learning algorithm.

Some examples of the method, UEs, and non-transitory computer-readable medium described herein may further include operations, features, means, or instructions for transmitting, to the network entity, a request to initialize perception-assisted beam management and receiving an acknowledgment message in response to the request, selecting the receive beam for each transmit beam in accordance with the perception information may be in accordance with receiving the acknowledgment message.

In some examples of the method, UEs, and non-transitory computer-readable medium described herein, the UE may be a vehicular UE (vUE).

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports perception assisted beam management for wireless communication vehicles.

FIG. 2 shows an example of a resource diagram usable for measurements that support perception assisted beam management for wireless communication vehicles.

FIG. 3 shows an example of an environment prediction procedure that may be implemented by wireless devices and that supports perception assisted beam management for wireless communication vehicles.

FIG. 4 shows an example of an environment prediction procedure that may be implemented by wireless devices and that supports perception assisted beam management for wireless communication vehicles.

FIGS. 5 and 6 show block diagrams of devices that may implement environment prediction procedures to support perception assisted beam management for wireless communication vehicles.

FIG. 7 shows a block diagram of a communications manager that may implement environment prediction procedures to support perception assisted beam management for wireless communication vehicles.

FIG. 8 shows a diagram of a system including a device which may implement environment prediction procedures to support perception assisted beam management for wireless communication vehicles.

FIG. 9 shows a flowchart illustrating methods that support perception assisted beam management for wireless communication vehicles.

### DETAILED DESCRIPTION

In some examples of wireless communications, a network entity and a user equipment (UE) may communicate via one or more directional beams used to establish and maintain a connection between the UE and the network entity. For instance, the network entity may communicate with the UE via one or more transmit beams (such as directional radio waves emitted by the network entity towards the UE), and the UE may communicate with the network entity via one or more receive beams (such as radio waves directed from the UE to the network entity, used to receive data at the UE). In some examples, the network entity and the UE may perform one or more beam management procedures to pair a given transmit beam with a given receive beam to generate a beam pair link (BPL).

In some examples of determining a BPL, the UE may receive a first quantity of synchronization signals blocks (SSBs) corresponding to a same first quantity of transmit beams. Additionally, the UE may receive a given SSB for a given transmit beam using multiple candidate receive beams and measure a signal quality for each of the multiple candidate receive beams. As such, the UE may select a receive beam with a highest signal quality to pair with the given transmit beam. In some examples, the UE may perform multiple signal quality measurements via multiple candidate receive beams for each of the first quantity of transmit beams. That is, the UE and network entity may operate in accordance with a round robin schedule in which the UE may measure the signal quality of each of the first quantity of SSBs (N) using each of a second quantity of candidate receive beams (M), where the time to perform each of the measurements increases relative to the product of the first quantity and the second quantity (N*M). As such, the use of a round robin schedule may increase the latency for finding each of the BPLs, where the latency may be above a tolerance threshold for one or more types of applications (such as video streaming). Additionally, or alternatively, the time to perform the round robin schedule may result in a staleness of the signal quality measurements performed. For instance, by the time the UE measures each possible BPL, changes in environmental conditions may reduce the accuracy of the measurements. Additionally, or alternatively, the round robin schedule may be associated with power expenditure overhead at the UE.

According to the techniques described herein, a UE may perform a perception-assisted beam management procedure to reduce the latency, improve accuracy, and/or reduce power expenditure overhead associated with determining BPLs. For example, a UE in a mobile environment (such as a vehicular UE (vUE)) may capture image-based sensing data (such as advanced driver assistance system (ADAS) technologies) to obtain feature maps of a spatial environment surrounding the UE. As such, the UE may use the feature maps to reduce a candidate receive beam search space for each transmit beam of the first quantity of transmit beams. For instance, if the UE determines based on the feature maps that a given candidate receive beam may bisect an environmental object (such as a physical barrier including trees, buildings, among other examples) the UE may determine to refrain from performing measurements using the given candidate receive beam. As such, by using the obtained feature maps, the UE may reduce the candidate receive beam search space, which may reduce the duration associated with performing the perception-assisted beam management procedure.

Particular aspects of the subject matter described in this disclosure can be implemented to realize one or more of the following potential advantages. For instance, the techniques described may leverage sensing data collected by UEs (such as vUEs) using one or more types of ADAS technologies. Such leveraged sensing data (such as perception of the environment) may be used to improve beam management and beam tracking methods, which may counter higher propagation loss and/or increased vulnerability to blockages characteristics of millimeter wave (mmWave) beams. Additionally, or alternatively, the techniques provide a framework for jointly simulating coordinated instances of the physical and radio frequency (RF) environments. For example, the framework may provide for the generation of high-fidelity, scalable, synthetic, and parametric datasets for vision-aided machine learning or non-machine learning solutions for wireless communications. By jointly simulating physical and RF environments, the UE may realize a reduction in latency communications, an increase in accuracy of signal measurements, and in a reduction in power expenditure at the UE.

Aspects of the disclosure are initially described in the context of wireless communications systems, a signaling diagram, and environment prediction procedures. Aspects of the disclosure are further illustrated by and described with reference to apparatus diagrams, system diagrams, and flowcharts that relate to perception assisted beam management for wireless communication vehicles.

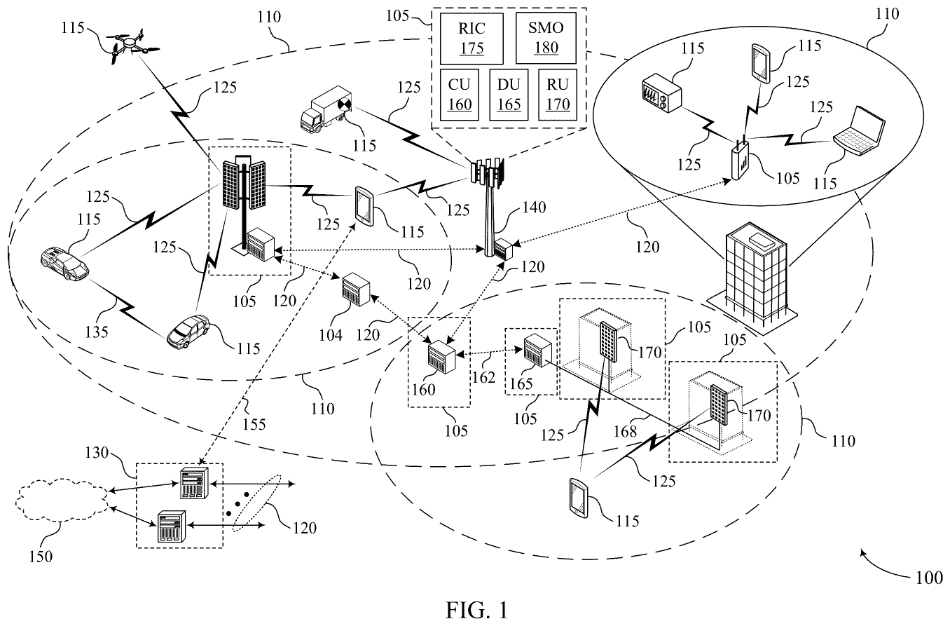

FIG. 1 shows an example of a wireless communications system 100 that supports perception assisted beam management for wireless communication vehicles. The wireless communications system 100 may include one or more devices, such as one or more network devices (such as network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (such as a radio frequency (RF) access link). For example, a network entity 105 may support a coverage area 110 (such as a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (such as other wireless communication devices, including UEs 115 or network entities 105), as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (such as in accordance with an S1, N2, N3, or other interface protocol). In some examples, network entities 105 may communicate with one another via backhaul communication link(s) 120 (such as in accordance with an X2, Xn, or other interface protocol) either directly (such as directly between network entities 105) or indirectly (such as via the core network 130). In some examples, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication link(s) 120, midhaul communication links 162, or fronthaul communication links 168 may be or include one or more wired links (such as an electrical link, an optical fiber link) or one or more wireless links (such as a radio link, a wireless optical link), among other examples or various combinations thereof. A UE 115 may communicate with the core network 130 via a communication link 155.

One or more of the network entities 105 or network equipment described herein may include or may be referred to as a base station 140 (such as a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (such as a base station 140) may be implemented in an aggregated (such as monolithic, standalone) base station architecture, which may be configured to utilize a protocol stack that is physically or logically integrated within one network entity (such as a network entity 105 or a single RAN node, such as a base station 140).

In some examples, a network entity 105 may be implemented in a disaggregated architecture (such as a disaggregated base station architecture, a disaggregated RAN architecture), which may be configured to utilize a protocol stack that is physically or logically distributed among multiple network entities (such as network entities 105), such as an integrated access and backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (such as a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some examples, one or more of the network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (such as layer 3 (L3), layer 2 (L2)) functionality and signaling (such as Radio Resource Control (RRC), service data adaptation protocol (SDAP), Packet Data Convergence Protocol (PDCP)). The CU 160 (such as one or more CUs) may be connected to a DU 165 (such as one or more DUs) or an RU 170 (such as one or more RUs), or some combination thereof, and the DUs 165, RUs 170, or both may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or multiple different RUs, such as an RU 170). In some cases, a functional split between a CU 160 and a DU 165 or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (such as F1, F1-c, F1-u), and a DU 165 may be connected to an RU 170 via a fronthaul communication link 168 (such as open fronthaul (FH) interface). In some examples, a midhaul communication link 162 or a fronthaul communication link 168 may be implemented in accordance with an interface (such as a channel) between layers of a protocol stack supported by respective network entities (such as one or more of the network entities 105) that are in communication via such communication links.

In some wireless communications systems (such as the wireless communications system 100), infrastructure and spectral resources for radio access may support wireless backhaul link capabilities to supplement wired backhaul connections, providing an IAB network architecture (such as to a core network 130). In some cases, in an IAB network, one or more of the network entities 105 (such as network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (such as IAB donors) may be in communication with one or more additional devices (such as IAB node(s) 104) via supported access and backhaul links (such as backhaul communication link(s) 120). IAB node(s) 104 may include an IAB mobile termination (IAB-MT) controlled (such as scheduled) by one or more DUs (such as DUs 165) of a coupled IAB donor. An IAB-MT may be equipped with an independent set of antennas for relay of communications with UEs 115 or may share the same antennas (such as of an RU 170) of IAB node(s) 104 used for access via the DU 165 of the IAB node(s) 104 (such as referred to as virtual IAB-MT (vIAB-MT)). In some examples, the IAB node(s) 104 may include one or more DUs (such as DUs 165) that support communication links with additional entities (such as IAB node(s) 104, UEs 115) within the relay chain or configuration of the access network (such as downstream). In such cases, one or more components of the disaggregated RAN architecture (such as the IAB node(s) 104 or components of the IAB node(s) 104) may be configured to operate according to the techniques described herein.

For instance, an access network (AN) or RAN may include communications between access nodes (such as an IAB donor), IAB node(s) 104, and one or more UEs 115. The IAB donor may facilitate connection between the core network 130 and the AN (such as via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (such as a backhaul link). The IAB donor and IAB node(s) 104 may communicate via an F1 interface according to a protocol that defines signaling messages (such as an F1 AP protocol). Additionally, or alternatively, the CU 160 may communicate with the core network 130 via an interface, which may be an example of a portion of a backhaul link, and may communicate with other CUs (such as including a CU 160 associated with an alternative IAB donor) via an Xn-C interface, which may be an example of another portion of a backhaul link.

IAB node(s) 104 may refer to RAN nodes that provide IAB functionality (such as access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (such as an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (such as the IAB node(s) 104) to receive signaling from a parent IAB node (such as the IAB node(s) 104), and a DU interface (such as a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (such as backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (such as transmissions to the UEs 115 relayed from the IAB donor) through one or more DUs (such as DUs 165). That is, data may be relayed to and from IAB node(s) 104 via signaling via an NR Uu interface to MT of IAB node(s) 104 (such as other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (such as a base station 140) may additionally, or alternatively, be performed by one or more components of the disaggregated RAN architecture (such as components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (such as one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (such as a bandwidth part (BWP)) that is operated according to one or more PHY layer channels for a given RAT (such as LTE, LTE-A, LTE-A Pro, NR). Each PHY layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a base station 140, a CU 160, a DU 165, a RU 170) of a RAN communicating with another device (such as directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (such as of the same or a different RAT).

The communication link(s) 125 of the wireless communications system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communications (such as in an FDD mode) or may be configured to carry downlink and uplink communications (such as in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (such as 1.4, 3, 5, 10, 15, 20, 40, or 80 megahertz (MHz)). Devices of the wireless communications system 100 (such as the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (such as a sub-band, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which case the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively-numbered subframes or slots, and each subframe or slot may have the same duration. In some examples, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some examples, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to UEs 115 (such as one or more UEs) or may include UE-specific search space sets for sending control information to a UE 115 (such as a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (such as using a carrier) and may be associated with an identifier for distinguishing neighboring cells (such as a physical cell identifier (PCID), a virtual cell identifier (VCID)). In some examples, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (such as several kilometers in radius) and may allow unrestricted access by the UEs 115 with service subscriptions with the network provider supporting the macro cell. A small cell may be associated with a network entity 105 operating with lower power (such as a base station 140 operating with lower power) relative to a macro cell, and a small cell may operate using the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (such as MTC, narrowband IoT (NB-IoT), enhanced mobile broadband (eMBB)) that may provide access for different types of devices.

In some examples, a network entity 105 (such as a base station 140, an RU 170) may be movable and therefore provide communication coverage for a moving coverage area, such as the coverage area 110. In some examples, coverage areas 110 (such as different coverage areas) associated with different technologies may overlap, but the coverage areas 110 (such as different coverage areas) may be supported by the same network entity (such as a network entity 105). In some other examples, overlapping coverage areas, such as a coverage area 110, associated with different technologies may be supported by different network entities (such as the network entities 105). The wireless communications system 100 may include, for example, a heterogeneous network in which different types of the network entities 105 support communications for coverage areas 110 (such as different coverage areas) using the same or different RATs.

The wireless communications system 100 may support synchronous or asynchronous operation. For synchronous operation, network entities 105 (such as base stations 140) may have similar frame timings, and transmissions from different network entities (such as different ones of the network entities 105) may be approximately aligned in time. For asynchronous operation, network entities 105 may have different frame timings, and transmissions from different network entities (such as different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (such as via Machine-to-Machine (M2M) communication). M2M communication or MTC may refer to data communication technologies that allow devices to communicate with one another or a network entity 105 (such as a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (such as a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (such as according to narrowband communications), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (such as one or more of the UEs 115) via a device-to-device (D2D) communication link, such as a D2D communication link 135 (such as in accordance with a peer-to-peer (P2P), D2D, or sidelink protocol). In some examples, one or more UEs 115 of a group that are performing D2D communications may be within the coverage area 110 of a network entity 105 (such as a base station 140, an RU 170), which may support aspects of such D2D communications being configured by (such as scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (such as UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (such as network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (such as less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (such as from 30 GHz to 300 GHz), also known as the millimeter band. In some examples, the wireless communications system 100 may support millimeter wave (mmWave) communications between the UEs 115 and the network entities 105 (such as base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (such as the same codeword) or different data streams (such as different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A network entity 105 or a UE 115 may use beam sweeping techniques as part of beamforming operations. For example, a network entity 105 (such as a base station 140, an RU 170) may use multiple antennas or antenna arrays (such as antenna panels) to conduct beamforming operations for directional communications with a UE 115. Some signals (such as synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (such as by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (such as a network entity 105 or a UE 115) along a single beam direction (such as a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (such as by a network entity 105 or a UE 115) may be performed using multiple beam directions, and the device may use a combination of digital precoding or beamforming to generate a combined beam for transmission (such as from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (such as a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted along one or more directions by a network entity 105 (such as a base station 140, an RU 170), a UE 115 may employ similar techniques for transmitting signals multiple times along different directions (such as for identifying a beam direction for subsequent transmission or reception by the UE 115) or for transmitting a signal along a single direction (such as for transmitting data to a receiving device).

A receiving device (such as a UE 115) may perform reception operations in accordance with multiple receive configurations (such as directional listening) when receiving various signals from a transmitting device (such as a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (such as when receiving a data signal). The single receive configuration may be aligned along a beam direction determined based on listening according to different receive configuration directions (such as a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (such as the communication link(s) 125, a D2D communication link 135). HARQ may include a combination of error detection (such as using a cyclic redundancy check (CRC)), forward error correction (FEC), and retransmission (such as automatic repeat request (ARQ)). HARQ may improve throughput at the MAC layer in relatively poor radio conditions (such as low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Expansion to mmWave frequencies may offer expansion of bandwidth and increased bit rates. Similarly, the introduction of advanced driver assistance system (ADAS) technologies may result in an increased amount of sensing data collected by vUEs. In some examples, sensing data (such as perception of aspects of the physical environment) may be used to improve beam management and beam tracking methods, which may counter the higher propagation loss and increased vulnerability to blockages characteristic of mmWave beams.

In some examples, performing beam management and mobility management for mmWave frequencies may be associated with updated transmission and control techniques relative to beam and mobility management using other frequencies. According to the techniques described herein, a vUE may identify transmission beam grouping based on spatial correlation, angle of arrival (AoA), as well as beam maintenance, and hierarchical beam search beam tracking/refinement for highly-directional beams, and such techniques may be applicable for mmWave frequencies for 5G and beyond. In some examples, deep-learning may be used to support beam management, and deep reinforcement learning may be used for beam management and power control for sub-6 GHz and mm Wave frequencies.

In some examples, the UE beam management techniques described herein may use image-based tracking of the environment, and use of the IMU sensor and camera sensor data may support improved beam management. In some examples, a coordinated radio frequency (RF)-sensing framework for parametric, scalable, synthetic data may be used to design and benchmark algorithms for wireless communications. In some examples, the data framework described herein may consider stationary cameras (such as cameras attached to the vUE). In some examples, beam management may consider image-based tracking of the environment using stationary cameras mounted at the network entities 105.

In some examples of wireless communications, a network entity 105 and a UE 115 may communicate via one or more directional beams used to establish and maintain a connection between the UE 115 and the network entity 105. For instance, the network entity 105 may communicate with the UE 115 via one or more transmit beams (such as directional radio waves emitted by the network entity 105 towards the UE 115), and the UE 115 may communicate with the network entity 105 via one or more receive beams (such as radio waves directed from the UE 115 to the network entity 105, used to receive data at the UE 115). In some examples, the network entity 105 and the UE 115 may perform one or more beam management procedures to pair a given transmit beam with a given receive beam to create a communication link referred to herein as a beam pair link (BPL).

In some examples of determining a BPL, the UE 115 may receive a first quantity of SSBs corresponding to a same first quantity of transmit beams. Additionally, the UE 115 may receive a given SSB for a given transmit beam using one of multiple candidate receive beams and measure a signal quality for the resulting BPL. As such, the UE 115 may select a receive beam with a highest signal quality to pair with the given transmit beam. In some examples, the UE 115 may perform multiple signal quality measurements via multiple candidate receive beams for each of the first quantity of transmit beams over multiple time instances. As such, when the quantity of candidate receive beams and the first quantity of transmit beams increases, the time dedicated to performing the BPL search procedure may increase, which may result in an increase in latency for wireless communication. Additionally, if environmental conditions change faster than the BPL search procedure is performed (such as in a high mobility environment for the UE 115), the RSRP measurements for the BPLs may become outdated, which may reduce the reliability of communications via one or more BPLs.

According to the techniques described herein, a UE 115 may perform a perception-assisted beam management procedure to reduce the latency associated with determining BPLs. For example, a UE 115 in a mobile environment (such as a vUE) may capture image-based sensing data to obtain feature maps of a spatial environment surrounding the UE 115. As such, the UE 115 may use the feature maps to reduce a candidate receive beam search space for each transmit beam of the first quantity of transmit beams. For instance, if the UE 115 determines, based on the feature maps, that a given candidate receive beam is occluded by an environmental object (such as a physical barrier including trees, buildings, among other examples) the UE 115 may determine to refrain from performing measurements using the given candidate receive beam. As such, by using the obtained feature maps, the UE 115 may reduce the candidate receive beam search space, which may reduce the duration associated with performing beam management procedures.

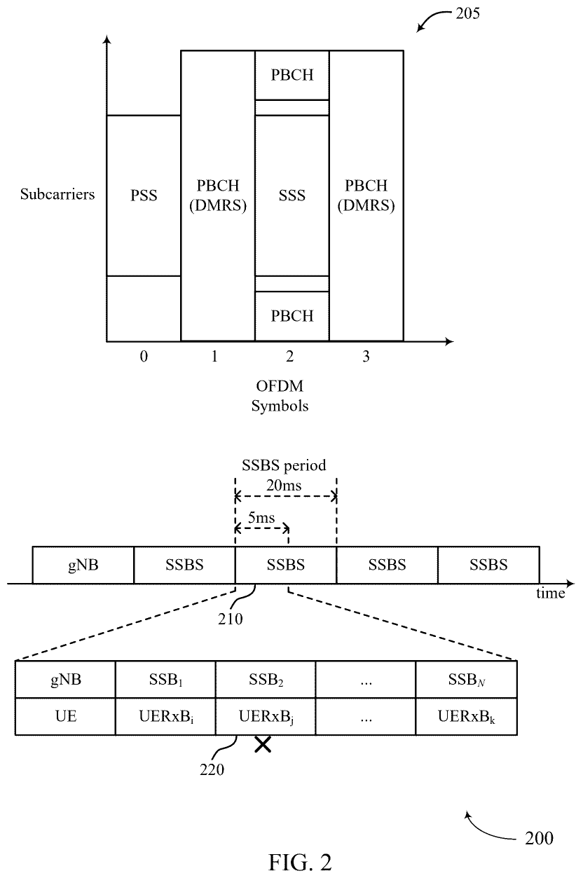

FIG. 2 shows an example of a resource diagram 200 usable for measurements that support perception assisted beam management for wireless communication vehicles. The signaling diagram 200 may be implemented by aspects of a wireless communications system described herein. For example, the signaling diagram 200 may be implemented by one or more UEs 115, one or more network entities 105, or both, as illustrated and described in wireless communications system 100 of FIG. 1.

In some examples of signaling diagram 200, a network entity 105 (such as gNB) may transmit beamformed reference signals (RSs) (such as SSBs) and perform transmission beam sweeping. A SSB 205 may contain, within one or more orthogonal frequency multiplexed (OFDM) symbols, various components or elements of information for establishing and maintaining wireless connections. The SSB 205 includes a primary synchronization signal (PSS), which may serves as the initial point for cell search and timing synchronization, helping UEs determine the physical layer cell identity. The SSB 205 also includes a secondary synchronization signal (SSS), which may provide additional cell identity information and assist with frame synchronization. The SSB 205 may also include a physical broadcast channel (PBCH), which may carry system information (such as a master information block (MIB)), which may include the system frame number, subcarrier spacing configuration, and cell barring information. To ensure proper demodulation of the PBCH, the PBCH may also include demodulation reference signals (DMRS), which are reference signals that enable accurate channel estimation and assist in beam management. As described herein, when the UE measures the SSB 205, the UE may measure the DMRSs included in the SSB 205. The SSB 205 structure may transmitted periodically, with multiple SSBs forming what is known as an SS burst set (SSBS) (such as an SSBS 210). The quantity of SSBs for each SSBS may vary depending on the frequency range being used, but SSB 205 may be used to facilitate initial cell search and access procedures for UEs connecting to the network.

During an SSBS (such as the SSBS 210), a network entity 105 (such as a gNB) may transmit multiple SSBs using different transmit beams. As illustrated, the gNB transmit SSB₁ to SSB_{N} during SSBS 210 and the UE may use different receive beams, such as the UE receive beams (UER×B), to receive the respective SSBs. This technique may be used to identify BPLs, as described herein. As illustrated, the UE uses UER×Bᵢ to UER×Bₖ to receive the SSBs during the SSBS 210.

To identify the BPLs, a UE 115 (such as vUE) may perform reference signal received power (RSRP) measurements and measurement database (MDB) logging using one or more SSBs (such as the SSB 205). In some examples, the UE 115 may report top beam(s) to the network entity 105. In some examples, the network entity 105 may perform transmission beam selection and send an indication of the selection to the UE 115, and the UE 115 may perform receive beam selection.

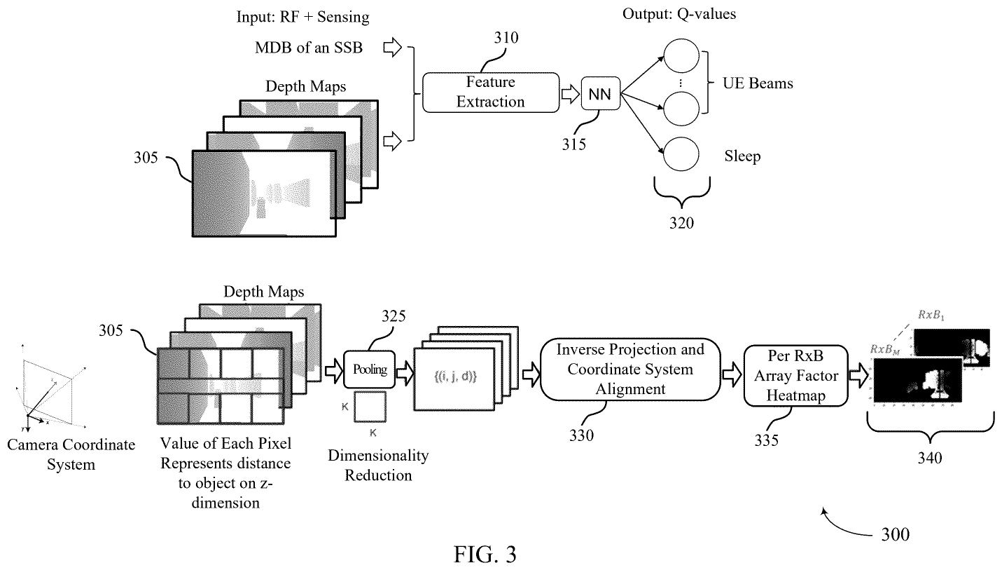

In one example, N SSBs may correspond to N transmit beams and M UE 115 receive beams, and the UE 115 may determine the BPL (transmit beam, receive beam) for use in communications. For example, the UE 115 may measure RSRP of a given SSB in an SSBS using one receive beam. In some examples, RSRP is measured using the SSS of the SSB and/or the DMRS of the PBCH of the SSB. In some examples, the receive beam search space size may be equal to M per SSB and M^{N} per synchronization signal burst set (SSBS). In some examples, the UE 115 may perform an exhaustive search of M*N BPLs via a round-robin on receive beams. Such examples may use M*SSBS period time to complete (such as M=64 and SSBS period=20 ms may involve 1.28 seconds), resulting in latency and staleness. As described herein, the UE may use environment detection and prediction to reduce the beam search space set and thus reduce the latency and staleness associated with beam management. For example, using the environment detection and prediction procedures described herein (such as the environment prediction procedure 300 of FIG. 3), the UE may remove the UER×Bⱼ 220 from the beam search space set, as the UE may determine or predict that this beam is blocked by something within the environment of the UE. Other possible actions as a result of the procedures described herein are contemplated within the scope of the present disclosure.

FIG. 3 shows an example of an environment prediction procedure 300 that may be implemented by wireless devices and that supports perception assisted beam management for wireless communication vehicles. The environment prediction procedure 300 may be implemented by aspects of a wireless communications system described herein. For example, the environment prediction procedure 300 may be implemented by one or more UEs 115, one or more network entities 105, or both, as illustrated and described in wireless communications system 100 of FIG. 1.

According to the techniques described herein, a UE 115 (such as vUE) may track the BPL between a network entity 105 and the UE 115 (such as while moving). Given that the UE 115 may use one receive beam to measure the RSRP for each transmit beam direction, it may be advantageous for the UE 115 to identify a receive beam for each transmit beam direction.

As illustrated in FIG. 3, the UE 115 may capture the trajectory using one or more inertial measurement unit (IMU) sensors and a 3D environment as depth maps 305 (such as outputted from ADAS cameras). In some examples, at 310, the UE 115 may correlate the RF-based data and the image-based sensing data to obtain or calculate feature maps of the environment. In some examples, the UE 115 may use the feature maps to reduce the receive beam search space and identify one or more receive beams for each transmit beam direction. In some examples, the UE 115 may use machine learning (ML)-based algorithms to perform one or more aspects of the techniques described herein (such as reinforcement learning (RL)). In some examples, the techniques may be extended to non-ML algorithms that may use non-ML search algorithms on a reduced receive beam search space derived from correlation-based feature maps of the environment.

For example, a neural network 315 may use the states of the feature maps obtained at 310 and assign values 320 (such as Q-values in the case of RL algorithms such as deep quality network (DQN)) associated with the action measuring the strength of a receive beam direction paired with a SSB direction based on a time and state of the feature maps. Additionally, the NN may also assign Q-values to the action of not measuring a receive beam direction paired with an SSB direction at a particular time and state of the feature map. The neural network 315 may learn or train based on selection of a greatest Q-value (such as an estimated value assigned to an action) and observing an obtained reward. The reward associated with sleep (such as not using any beam) in a time period may pertain to the energy saved by not applying the antenna elements associated with a SSB direction in a time period.

The depth maps 305 may be evaluated to determine depth, a distance of an object from a reference point along the z-axis of a chosen coordinate system with the xy-plane as a reference surface. For example, a value of a pixel within a depth map represents the distance of the corresponding object from the reference point. Similar to vision-based data such as RGB images, stereo (3-D) images and videos, the depth maps in 305 may have a larger array-type data structure. Pooling techniques may support scaling down the dimensionality of depth maps and other vision-based input types that may be supported in 305. For example, depth maps 305, RGB images, stereo images (such as 3-D images), and/or any associated video compositions may be used for the techniques described herein. At 325, a pooling operation may be performed and may relate to techniques such as 1-dimensional, 2-dimensional, and/or N-dimensional maximum pooling and average pooling in machine learning architectures

At 330, the devices may perform an inverse projection and coordinate system alignment procedure whereby the inversion of the depth map(s) may be performed to obtain the 3-dimensional locations of the points where the 3-dimensional coordinate system is aligned with the boresight of the receive beam at the UE. At 335, the devices may obtain a per-receive beam heatmap (such as heatmaps 340) of array factors. An array factor may refer to “the response function of an array of antenna elements.” In some examples, an array factor corresponding to each 3-dimensional point in the environment shown in the depth maps is generated, and the array factors may be represented as heatmaps 340 to represent the relative beam strength that can be expected from a spatial point along the receive beam direction.

In accordance with aspects described herein, a feature map may refer to a mapping between features of data (such as depth maps and inertial data) detected by various sensors of a device and the features of the radio frequency data. These feature maps may evolve as the depth maps, inertial data, and radio frequency data changes based on changes within the environment and the mobility of the vehicle.

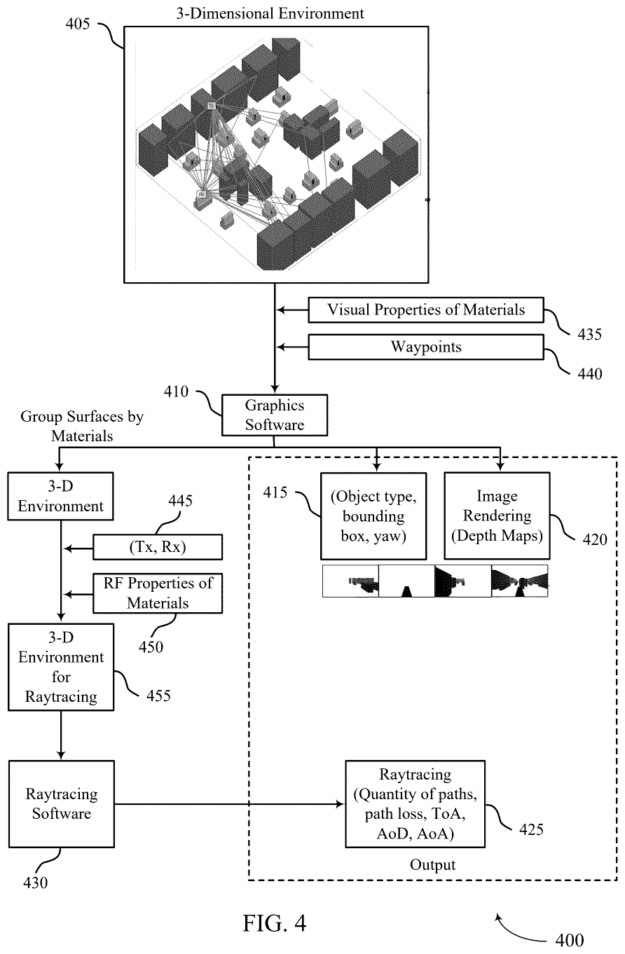

FIG. 4 shows an example of an environment prediction procedure 400 that may be implemented by wireless devices and that supports perception assisted beam management for wireless communication vehicles. The environment prediction procedure 400 may be implemented by aspects of a wireless communications system described herein. For example, the environment prediction procedure 400 may be implemented either jointly or independently by one or more UEs 115, one or more network entities 105, or both, as illustrated and described in wireless communications system 100 of FIG. 1.

In some examples of environment prediction procedure 400, the network entity 105 and/or the UE 115 may perform (and aggregate across multiple sources) measurements to provide sensing data (such as perception data such as depth maps and mobility data such as IMU readings). In some other examples of the environment prediction procedure 400, the network entity 105 and/or UE 115 may generate synthetic data (such as perception data such as depth maps and mobility data such as IMU readings sampled from past measurements and 3-D city models). The measured or synthesized sensing data uses a framework (such as the one illustrated in FIG. 4) to coordinate between the RF and sensing information (such as mobility and perception data) tracked in the environment. In some examples, the techniques may be extended to multiple data modalities (Vision (depth-based), Vision (RGB-based), RADAR, LIDAR, etc.). In some examples, the techniques may be extended to data collection across multiple sources. In some examples, the techniques may be extended to employ digital twin frameworks for deriving data from the environment as well as tracking any real-time changes occurring in the environment. In some examples, the techniques may be extended to have an adaptive data collection rate to utilize more or less information depending on the complexity of the environment and other factors. For instance, the environment prediction procedure 400 may implement an adaptive data collection rate, resulting in sensing information being captured less frequently for low-speed streets with no turns and an open sky (i.e., environments that are less dynamic and/or more predictable using the environment prediction procedure 300).

The environment prediction procedure 400 may utilize various techniques, such as raytracing to support prediction aspects. For example, a 3-dimensional environment 405 may be sensed and/or modeled and various data, such as visual properties of materials 435 and waypoints 440, may be input into a graphics software 410 (such as Blender), which may be used to create, manipulate, and render detailed 3D environments with realistic physics-based rendering, and texture mapping. The graphics software may be used to group aspects of the 3-dimensional environment by materials, after which the impact of the materials in the 3-dimensional environment on RF waves can be modeled using a raytracing software. Various communication properties of the environment such as signal transmission and reception data 445 (such as locations of transmitter-receiver pairs), radiofrequency (RF) properties of materials 450, and the modeled environment may be used to obtain a 3-dimensional environment for raytracing 455. The data associated with the 3-dimensional environment may be input into raytracing software 430 (such as Wireless Insite) that is used to analyze and predict radio wave propagation in a 3-dimensional environment and select beams for identification of BPLs. The raytracing techniques may be used to analyze the signal paths between various transmitters/receivers in the 3-dimensional environment 405. For example, the modeled environment may be analyzed to determine or predict a pathloss, time of arrival (ToA), angle of departure (AOD), angle of attack (AoA) for various signals and signal paths. Object types 415, depth maps 420, and/or raytracing data for signal paths 425 may be examples of output of the environment prediction procedure 400. This information may be used by the UE, the network entity, or both, to select (or deselect) candidate beams for establishing BPLs.

For example, based on the implementation choice of antenna array elements and the obtained raytracing outputs (such as signal paths 425), the devices may construct a genie measurement database (genie MDB) to capture the actual beam strengths of every pairing of SSB-R×Beam direction for a given configuration of the environment and transmitter/receiver devices. Each BPL may be an example of a unique pairing of SSB-R×Beam directions. In some examples, the object type outputs are tied with assigning a material during raytracing. However, if full color images (such as RGB images) are used, then the image data may be used to detect RF properties of the object by its materials and to predict additional details about object types. The neural network (such as the neural network 315 of FIG. 3) may improve the estimation of relative beam strength to be expected from a three-dimensional spatial point based on the object type/material.

The UE 115 may transmit to the network entity 105 (such as central entity) a UE 115 status. In some examples, the UE 115 status (such as reception status) may include the target area, velocity, heading, memory and computational capacity of onboard computer, capabilities (such as field-of-view, resolution, range) of the cameras and other modalities of sensing. In some examples, the UE 115 may receive from the network entity 105 a gNB status and operational parameters. In some examples, the gNB status may include N (such as a quantity of SSBs for the transmit beams), SSBS periodicity, etc. In some examples, the operational parameters may include sensor settings, parameters for the algorithms that perform one or more of post-processing of the image/sensing/RF information, feature extraction from the sensing/RF information, and beam management.

In some examples, the UE 115 may obtain a first camera image (depth map, RGB) at a first time instant from the set of camera imaging instances. In some cases, the UE 115 may obtain a first RADAR point cloud at a fourth time instant from the set of RADAR mapping instances. In some cases, if applicable, the UE 115 may obtain a first LIDAR point cloud at a fifth time instant from the set of LIDAR mapping instances. In some examples, the UE 115 may obtain a first IMU log (such as speed, heading, angular velocity, etc.) at the first time instant from the set of camera imaging instances. In some examples, the UE 115 may receive, from the central entity, a first set of N SSBs at a second time instant (such as i^{th} SSBS) from the set of SSBS instances. As such, the UE 115 may measure the RSRP of the n^{th} transmit beam and the receive beam chosen to receive the n^{th} SSB to create the first MDB.

Additionally, or alternatively, the UE 115 may obtain a second IMU log (such as speed, heading, angular velocity, etc.) at the second time instant from the set of SSBS instances (such as i^{th} SSBS). In some examples, the UE 115 may use the first camera image, the first IMU log, and the second IMU log to derive a second predicted camera image for the second time instant (i.e., i^{th} SSBS). In some cases, the UE 115 may use the second predicted camera image and first MDB to derive a first set of spatial feature maps corresponding to each of the receive beams. In one case, the spatial feature map corresponding to a receive beam may be the relative beam strength expected from a spatial point based on the 3D location of the spatial point relative to the vUE, and the beam gains of the receive beam. In one case, the spatial feature map corresponding to a receive beam is the relative beam strength expected from a spatial point based on the 3D location of the spatial point relative to the UE 115, the beam weights of the receive beam, object types (such as make and model of car, 3D model of a known building), and the RF properties of the material composition (such as metal, glass) at the spatial point.

Additionally, or alternatively, the UE 115 may obtain a third IMU log (such as speed, heading, angular velocity, etc.) at a third time instant from the set of SSBS instances (such as (i+1)^{th} SSBS). In some examples, the UE 115 may use the first and second camera images and use the first, second, and third IMU logs to derive a third predicted camera image for the third time instant (such as (i+1)^{th} SSBS). In some examples, the UE 115 may use the third predicted camera image and first MDB to derive a second set of spatial feature maps corresponding to each of the receive beams.

As such, the UE 115 may determine a first combined feature map for the third time instant (such as (i+1)^{th} SSBS) using the first set of spatial feature maps (such as corresponding to the top k receive beams from the first MDB for each SSB), and the second set of spatial feature maps (such as corresponding to all candidate receive beams for each SSB). In some examples, the UE 115 may calculate the first combined feature map using a similarity measure, a neural network, or a combination of both.

In some examples, the UE 115 may use the first combined feature map to determine the receive beam that the UE 115 may use to measure the RSRP corresponding to each of the N SSBs at third time instant (such as (i+1)^{th} SSBS). In a first case, there may be no receive beam assigned to measure the RSRP corresponding to one or more of the N SSBs (such as to consume less power). In a second case, there may be no receive beam assigned to measure the RSRP corresponding to any of the N SSBs (such as to consume less power). In a third case, there may be an receive beam assigned to measure the RSRP corresponding to each of the N SSBs (such as improve RSRP).

In some examples, the UE 115 may determine the first combined feature map by the using a non-ML or an ML algorithm. In some examples, the ML algorithms may be trained by using rewards for actions that improve key metrics (such as RSRP of the serving beam, power conserved in beam switching, power conserved in beam measurement, etc.)

If the gNB status or operational parameters received by the UE 115 contain a first indication, the UE 115 may transmit, to the network entity 105, an experience replay corresponding to the third time instant. For instance, the experience replay may include the first MDB, the first, second, and third camera images, the first and second spatial feature maps, and the first combined feature maps along with the outputs of the non-ML/ML algorithms. The information included in the experience replay may be used for further training of ML algorithms and/or to derive performance metrics.

In some examples, the network entity 105 may receive, from the UE 115, a request to initialize perception-assisted beam management. As such, the network entity 105 may transmit an acknowledgment (ACK) in response to the request. In the event of sufficient change, the network entity 105 may receive an updated UE 115 status from the UE 115 device. For instance, the new UE 115 status may include one or more of an updated target area, an updated velocity, an updated heading, or an updated range. In response, the network entity 105 may transmit updated operational parameters to the UE 115 device. For instance, the updated operational parameters may include one or more of updated designated algorithms, updated parameters for the sensors, and updated parameters for the designated algorithms.

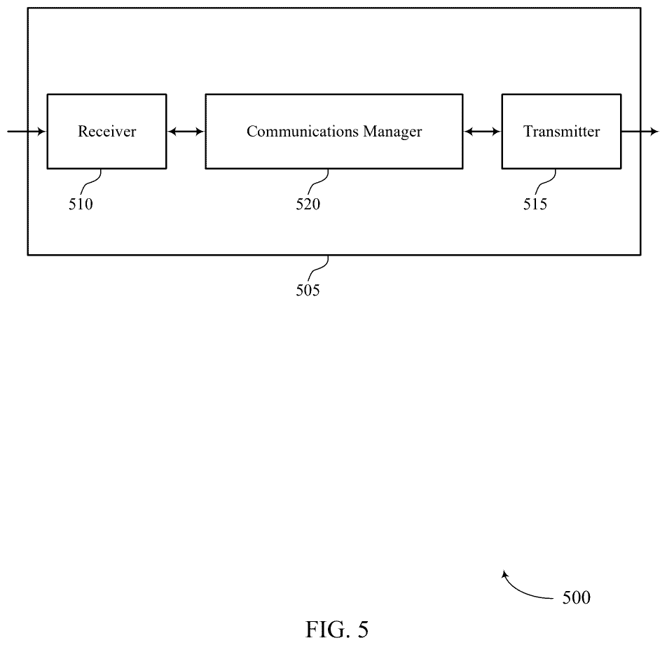

FIG. 5 shows a block diagram 500 of a device 505 that may implement

environment prediction procedures to support perception assisted beam management for wireless communication vehicles. The device 505 may be an example of aspects of a UE 115 as described herein. The device 505 may include a receiver 510, a transmitter 515, and a communications manager 520. The device 505, or one or more components of the device 505 (such as the receiver 510, the transmitter 515, the communications manager 520), may include at least one processor, which may be coupled with at least one memory, to, individually or collectively, support or enable the described techniques. Each of these components may be in communication with one another (such as via one or more buses).

The receiver 510 may provide a means for receiving information such as packets, user data, control information, or any combination thereof associated with various information channels (such as control channels, data channels, information channels related to perception assisted beam management for wireless communication vehicles). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (such as control channels, data channels, information channels related to perception assisted beam management for wireless communication vehicles). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of perception assisted beam management for wireless communication vehicles as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (such as in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 520, the receiver 510, the transmitter 515, or various combinations or components thereof may be implemented in code (such as communications management software or firmware) executed by at least one processor (such as referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 520 may be configured to perform various operations (such as receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining a set of multiple transmit beams associated with a network entity, where a set of multiple candidate receive beams associated with the UE correspond to the set of multiple transmit beams. The communications manager 520 is capable of, configured to, or operable to support a means for obtaining, from one or more sensors associated with the UE, perception information indicative of an expected environment of the UE, where the perception information includes mobility information, spatial information, and additional information associated with the UE. The communications manager 520 is capable of, configured to, or operable to support a means for selecting, in accordance with the perception information and the expected environment of the UE, a receive beam from the set of multiple candidate receive beams to measure a strength of reference signals transmitted by each transmit beam of the set of multiple transmit beams. The communications manager 520 is capable of, configured to, or operable to support a means for receiving one or more reference signals and related signals from the set of multiple transmit beams via one or more of the selected receive beams.

By including or configuring the communications manager 520 in accordance with examples as described herein, the device 505 (such as at least one processor controlling or otherwise coupled with the receiver 510, the transmitter 515, the communications manager 520, or a combination thereof) may support techniques for reduced processing, reduced power consumption, and more efficient utilization of communication resources.

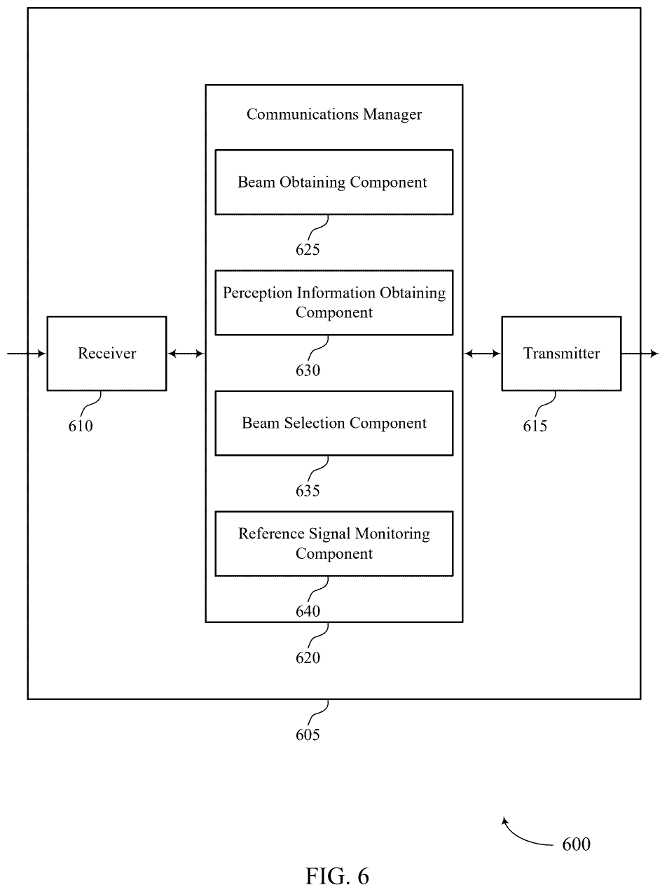

FIG. 6 shows a block diagram 600 of a device 605 that may implement environment prediction procedures to support perception assisted beam management for wireless communication vehicles. The device 605 may be an example of aspects of a device 505 or a UE 115 as described herein. The device 605 may include a receiver 610, a transmitter 615, and a communications manager 620. The device 605, or one or more components of the device 605 (such as the receiver 610, the transmitter 615, the communications manager 620), may include at least one processor, which may be coupled with at least one memory, to support the described techniques. Each of these components may be in communication with one another (such as via one or more buses).

The receiver 610 may provide a means for receiving information such as packets, user data, control information, or any combination thereof associated with various information channels (such as control channels, data channels, information channels related to perception assisted beam management for wireless communication vehicles). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (such as control channels, data channels, information channels related to perception assisted beam management for wireless communication vehicles). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of perception assisted beam management for wireless communication vehicles as described herein. For example, the communications manager 620 may include a beam obtaining component 625, a perception information obtaining component 630, a beam selection component 635, a reference signal monitoring component 640, or any combination thereof. The communications manager 620 may be an example of aspects of a communications manager 520 as described herein. In some examples, the communications manager 620, or various components thereof, may be configured to perform various operations (such as receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The beam obtaining component 625 is capable of, configured to, or operable to support a means for obtaining a set of multiple transmit beams associated with a network entity, where a set of multiple candidate receive beams associated with the UE correspond to the set of multiple transmit beams. The perception information obtaining component 630 is capable of, configured to, or operable to support a means for obtaining, from one or more sensors associated with the UE, perception information indicative of an expected environment of the UE, where the perception information includes mobility information, spatial information, and additional information associated with the UE. The beam selection component 635 is capable of, configured to, or operable to support a means for selecting, in accordance with the perception information and the expected environment of the UE, a receive beam from the set of multiple candidate receive beams to measure a strength of reference signals transmitted by each transmit beam of the set of multiple transmit beams. The reference signal monitoring component 640 is capable of, configured to, or operable to support a means for receiving one or more reference signals and related signals from the set of multiple transmit beams via one or more of the selected receive beams.

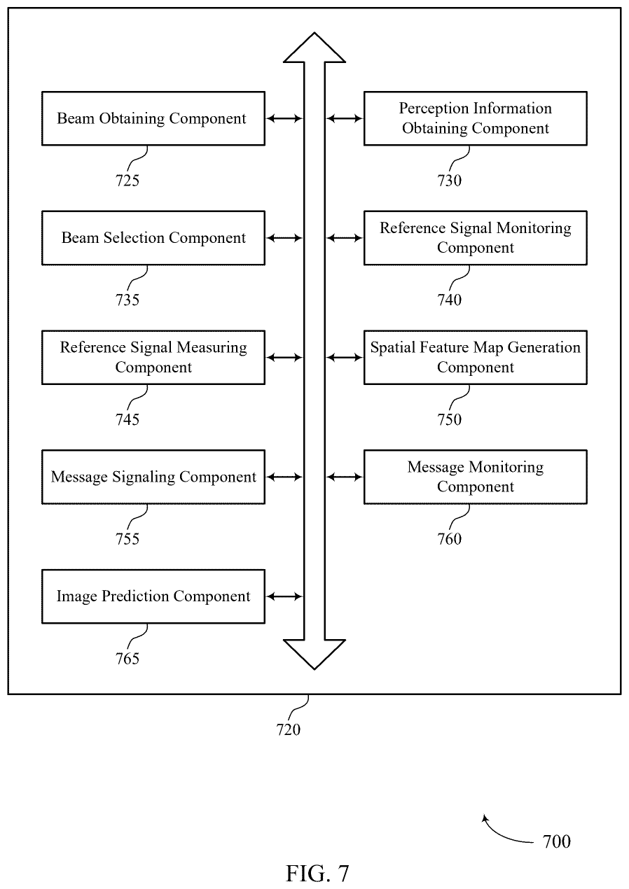

FIG. 7 shows a block diagram 700 of a communications manager 720 that may implement environment prediction procedures to support perception assisted beam management for wireless communication vehicles. The communications manager 720, which may be implemented in a UE, may be an example of aspects of a communications manager 520, a communications manager 620, or both, as described herein. The communications manager 720, or various components thereof, may be an example of means for performing various aspects of perception assisted beam management for wireless communication vehicles as described herein. For example, the communications manager 720 may include a beam obtaining component 725, a perception information obtaining component 730, a beam selection component 735, a reference signal monitoring component 740, a reference signal measuring component 745, a spatial feature map generation component 750, a message signaling component 755, a message monitoring component 760, an image prediction component 765, or any combination thereof. Each of these components, or components or subcomponents thereof (such as one or more processors, one or more memories), may communicate, directly or indirectly, with one another (such as via one or more buses).

The communications manager 720 may support wireless communications in accordance with examples as disclosed herein. The beam obtaining component 725 is capable of, configured to, or operable to support a means for obtaining a set of multiple transmit beams associated with a network entity, where a set of multiple candidate receive beams associated with the UE correspond to the set of multiple transmit beams. The perception information obtaining component 730 is capable of, configured to, or operable to support a means for obtaining, from one or more sensors associated with the UE, perception information indicative of an expected environment of the UE, where the perception information includes mobility information, spatial information, and additional information associated with the UE. The beam selection component 735 is capable of, configured to, or operable to support a means for selecting, in accordance with the perception information and the expected environment of the UE, a receive beam from the set of multiple candidate receive beams to measure a strength of reference signals transmitted by each transmit beam of the set of multiple transmit beams. The reference signal monitoring component 740 is capable of, configured to, or operable to support a means for receiving one or more reference signals and related signals from the set of multiple transmit beams via one or more of the selected receive beams.

In some examples, the perception information obtaining component 730 is capable of, configured to, or operable to support a means for obtaining, over one or more durations, one or more camera images associated with a set of multiple camera imaging instances and one or more inertial measurement unit (IMU) logs associated with a set of multiple IMU logging instances, the perception information including the one or more camera images and the one or more IMU logs.

In some examples, the image prediction component 765 is capable of, configured to, or operable to support a means for generating one or more pluralities of predicted camera images indicative of the expected environment of the UE in accordance with the one or more camera images and the one or more IMU logs.

In some examples, each camera image of the one or more camera images includes a depth map and a color model associated with a spatial environment of the UE. In some examples, each IMU log of the one or more IMU logs includes inertial information of the UE relative to the spatial environment of the UE, the inertial information including one or more of a speed of the UE, spatial directionality of the UE, an angular velocity of the UE, or a combination thereof.

In some examples, the reference signal measuring component 745 is capable of, configured to, or operable to support a means for measuring a received strength of a first set of multiple SSBs associated with the set of multiple transmit beams for generation of a first measurement database at a first SSBS instance, where reception of the first set of multiple SSBs is associated with one of a set of multiple SSBS instances. In some examples, the spatial feature map generation component 750 is capable of, configured to, or operable to support a means for generating a first set of multiple spatial feature maps associated with the set of multiple candidate receive beams in accordance with the first measurement database, the perception information, and a first set of multiple predicted images generated for the first SSBS instance.

In some examples, each spatial feature map of the first set of multiple spatial feature maps is a mapping of predicted beam strength values for each of the set of multiple candidate receive beams for spatial points associated with a spatial environment of the UE.

In some examples, the spatial feature map generation component 750 is capable of, configured to, or operable to support a means for generating a second set of multiple spatial feature maps associated with the set of multiple candidate receive beams in accordance with the first measurement database, the perception information, a first set of multiple predicted camera images, and a second set of multiple predicted camera images associated with the expected environment of the UE at a future SSBS instance. In some examples, the spatial feature map generation component 750 is capable of, configured to, or operable to support a means for generating a combined spatial feature map in accordance with the first set of multiple spatial feature maps and the second set of multiple spatial feature maps, the combined spatial feature map corresponding to the expected environment of the UE and resulting changes in predicted beam strength values for the set of multiple candidate receive beams.

In some examples, the message signaling component 755 is capable of, configured to, or operable to support a means for transmitting, to the network entity, a UE status indication that includes one or more of a spatial target area, a velocity of the UE, a memory and computational capacity of a computer of the UE, and capability information associated with the one or more sensors.

In some examples, the message monitoring component 760 is capable of, configured to, or operable to support a means for receiving, from the network entity, a network entity status indication and one or more operational parameters, the network entity status indication including an indication of a quantity of SSBs associated with the set of multiple transmit beams and a periodicity of a SSBS, the one or more operational parameters including one or more of sensor settings for the one or more sensors associated with the UE and one or more parameters for one or more algorithms at the UE.

In some examples, the message signaling component 755 is capable of, configured to, or operable to support a means for transmitting, to the network entity in accordance with receiving a first indication to transmit an experience replay, the first indication included in the network entity status indication or in the one or more operational parameters, the experience replay including one or more portions of information used by the UE in the selection of the receive beam for each transmit beam of the set of multiple transmit beams, the one or more portions of information including one or more of the perception information, a status of the expected environment, one or more algorithmic outputs of the one or more algorithms designated for beam management using the perception information, or a combination thereof.

In some examples, the selection, in accordance with the perception information, of the receive beam for measuring the strength of reference signal of each transmit beam of the set of multiple transmit beams is in accordance with a machine learning algorithm or a non-machine learning algorithm.

In some examples, the message signaling component 755 is capable of, configured to, or operable to support a means for transmitting, to the network entity, a request to initialize perception-assisted beam management. In some examples, the message monitoring component 760 is capable of, configured to, or operable to support a means for receiving an acknowledgment message in response to the request, selecting the receive beam for each transmit beam in accordance with the perception information is in accordance with receiving the acknowledgment message.

In some examples, the UE is a vehicular UE (vUE).

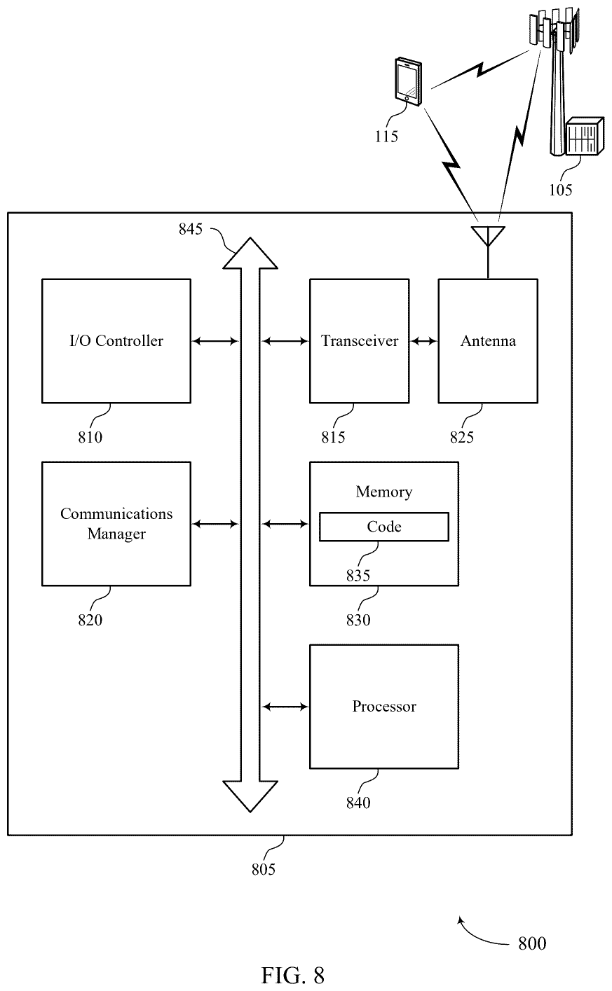

FIG. 8 shows a diagram of a system 800 including a device 805 that may implement environment prediction procedures to support perception assisted beam management for wireless communication vehicles. The device 805 may be an example of or include components of a device 505, a device 605, or a UE 115 as described herein. The device 805 may communicate (such as wirelessly) with one or more other devices (such as network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (such as operatively, communicatively, functionally, electronically, electrically) via one or more buses (such as a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (such as when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (such as the at least one memory 830) to cause the device 805 to perform various functions (such as functions or tasks supporting perception assisted beam management for wireless communication vehicles). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (such as processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for obtaining a set of multiple transmit beams associated with a network entity, where a set of multiple candidate receive beams associated with the UE correspond to the set of multiple transmit beams. The communications manager 820 is capable of, configured to, or operable to support a means for obtaining, from one or more sensors associated with the UE, perception information indicative of an expected environment of the UE, where the perception information includes mobility information, spatial information, and additional information associated with the UE. The communications manager 820 is capable of, configured to, or operable to support a means for selecting, in accordance with the perception information and the expected environment of the UE, a receive beam from the set of multiple candidate receive beams to measure a strength of reference signals transmitted by each transmit beam of the set of multiple transmit beams. The communications manager 820 is capable of, configured to, or operable to support a means for receiving one or more reference signals and related signals from the set of multiple transmit beams via one or more of the selected receive beams.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (such as receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of perception assisted beam management for wireless communication vehicles as described herein, or the at least one processor 840 and the at least one memory 830 may be otherwise configured to, individually or collectively, perform or support such operations.

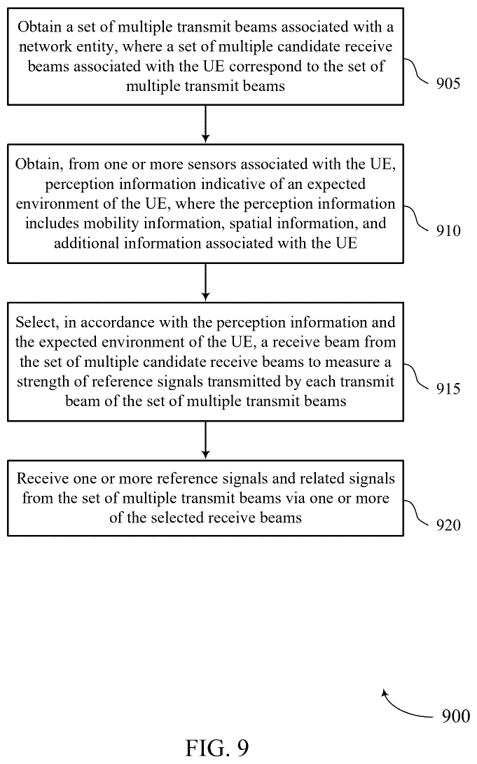

FIG. 9 shows a flowchart illustrating a method 900 that supports perception assisted beam management for wireless communication vehicles. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include obtaining a set of multiple transmit beams associated with a network entity, where a set of multiple candidate receive beams associated with the UE correspond to the set of multiple transmit beams. The operations of 905 may be performed in accordance with examples as disclosed herein. In some examples, aspects of the operations of 905 may be performed by a beam obtaining component 725 as described with reference to FIG. 7.

At 910, the method may include obtaining, from one or more sensors associated with the UE, perception information indicative of an expected environment of the UE, where the perception information includes mobility information, spatial information, and additional information associated with the UE. The operations of 910 may be performed in accordance with examples as disclosed herein. In some examples, aspects of the operations of 910 may be performed by a perception information obtaining component 730 as described with reference to FIG. 7.

At 915, the method may include selecting, in accordance with the perception information and the expected environment of the UE, a receive beam from the set of multiple candidate receive beams to measure a strength of reference signals transmitted by each transmit beam of the set of multiple transmit beams. The operations of 915 may be performed in accordance with examples as disclosed herein. In some examples, aspects of the operations of 915 may be performed by a beam selection component 735 as described with reference to FIG. 7.

At 920, the method may include receiving one or more reference signals and related signals from the set of multiple transmit beams via one or more of the selected receive beams. The operations of 920 may be performed in accordance with examples as disclosed herein. In some examples, aspects of the operations of 920 may be performed by a reference signal monitoring component 740 as described with reference to FIG. 7.

The following provides an overview of aspects of the present disclosure:

Aspect 1: A method for wireless communications, at a UE, comprising: obtaining a plurality of transmit beams associated with a network entity, wherein a plurality of candidate receive beams associated with the UE correspond to the plurality of transmit beams; obtaining, from one or more sensors associated with the UE, perception information indicative of an expected environment of the UE, wherein the perception information comprises mobility information, spatial information, and additional information associated with the UE; selecting, in accordance with the perception information and the expected environment of the UE, a receive beam from the plurality of candidate receive beams to measure a strength of reference signals transmitted by each transmit beam of the plurality of transmit beams; and receiving one or more reference signals and related signals from the plurality of transmit beams via one or more of the selected receive beams.

Aspect 2: The method of aspect 1, further comprising: obtaining, over one or more durations, one or more camera images associated with a plurality of camera imaging instances and one or more IMU logs associated with a plurality of IMU logging instances, the perception information comprising the one or more camera images and the one or more IMU logs.

Aspect 3: The method of aspect 2, further comprising: generating one or more pluralities of predicted camera images indicative of the expected environment of the UE in accordance with the one or more camera images and the one or more IMU logs.

Aspect 4: The method of any of aspects 2 through 3, wherein each camera image of the one or more camera images comprises a depth map and a color model associated with a spatial environment of the UE, and each IMU log of the one or more IMU logs comprises inertial information of the UE relative to the spatial environment of the UE, the inertial information comprising one or more of a speed of the UE, spatial directionality of the UE, an angular velocity of the UE, or a combination thereof.

Aspect 5: The method of any of aspects 1 through 4, further comprising: measuring a received strength of a first plurality of SSBs associated with the plurality of transmit beams for generation of a first measurement database at a first SSBS instance, wherein reception of the first plurality of SSBs is associated with one of a plurality of SSBS instances; and generating a first plurality of spatial feature maps associated with the plurality of candidate receive beams in accordance with the first measurement database, the perception information, and a first plurality of predicted images generated for the first SSBS instance.

Aspect 6: The method of aspect 5, wherein each spatial feature map of the first plurality of spatial feature maps is a mapping of predicted beam strength values for each of the plurality of candidate receive beams for spatial points associated with a spatial environment of the UE.

Aspect 7: The method of any of aspects 5 through 6, further comprising: generating a second plurality of spatial feature maps associated with the plurality of candidate receive beams in accordance with the first measurement database, the perception information, a first plurality of predicted camera images, and a second plurality of predicted camera images associated with the expected environment of the UE at a future SSBS instance; and generating a combined spatial feature map in accordance with the first plurality of spatial feature maps and the second plurality of spatial feature maps, the combined spatial feature map corresponding to the expected environment of the UE and resulting changes in predicted beam strength values for the plurality of candidate receive beams.

Aspect 8: The method of any of aspects 1 through 7, further comprising: transmitting, to the network entity, a UE status indication that comprises one or more of a spatial target area, a velocity of the UE, a memory and computational capacity of a computer of the UE, and capability information associated with the one or more sensors.

Aspect 9: The method of any of aspects 1 through 8, further comprising: receiving, from the network entity, a network entity status indication and one or more operational parameters, the network entity status indication comprising an indication of a quantity of SSBs associated with the plurality of transmit beams and a periodicity of a SSBS, the one or more operational parameters comprising one or more of sensor settings for the one or more sensors associated with the UE and one or more parameters for one or more algorithms at the UE.

Aspect 10: The method of aspect 9, further comprising: transmitting, to the network entity in accordance with receiving a first indication to transmit an experience replay, the first indication comprised in the network entity status indication or in the one or more operational parameters, the experience replay comprising one or more portions of information used by the UE in the selection of the receive beam for each transmit beam of the plurality of transmit beams, the one or more portions of information comprising one or more of the perception information, a status of the expected environment, one or more algorithmic outputs of the one or more algorithms designated for beam management using the perception information, or a combination thereof.

Aspect 11: The method of any of aspects 1 through 10, wherein the selection, in accordance with the perception information, of the receive beam for measuring the strength of reference signal of each transmit beam of the plurality of transmit beams is in accordance with a machine learning algorithm or a non-machine learning algorithm.

Aspect 12: The method of any of aspects 1 through 11, further comprising: transmitting, to the network entity, a request to initialize perception-assisted beam management; and receiving an acknowledgment message in response to the request, selecting the receive beam for each transmit beam in accordance with the perception information is in accordance with receiving the acknowledgment message.

Aspect 13: The method of any of aspects 1 through 12, wherein the UE is a VUE.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (such as a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
obtain a plurality of transmit beams associated with a network entity, wherein a plurality of candidate receive beams associated with the UE correspond to the plurality of transmit beams;
obtain, from one or more sensors associated with the UE, perception information indicative of an expected environment of the UE, wherein the perception information comprises mobility information, spatial information, and additional information associated with the UE;
select, in accordance with the perception information and the expected environment of the UE, a receive beam from the plurality of candidate receive beams to measure a strength of reference signals transmitted by each transmit beam of the plurality of transmit beams; and
receive one or more reference signals and related signals from the plurality of transmit beams via one or more of the selected receive beams.

2. The UE of claim 1, wherein the one or more processors are individually or collectively further operable to execute the code to cause the UE to:
obtain, over one or more durations, one or more camera images associated with a plurality of camera imaging instances and one or more inertial measurement unit (IMU) logs associated with a plurality of IMU logging instances, the perception information comprising the one or more camera images and the one or more IMU logs.

3. The UE of claim 2, wherein the one or more processors are individually or collectively further operable to execute the code to cause the UE to:
generate one or more pluralities of predicted camera images indicative of the expected environment of the UE in accordance with the one or more camera images and the one or more IMU logs.

4. The UE of claim 2, wherein:
each camera image of the one or more camera images comprises a depth map and a color model associated with a spatial environment of the UE; and
each IMU log of the one or more IMU logs comprises inertial information of the UE relative to the spatial environment of the UE, the inertial information comprising one or more of a speed of the UE, spatial directionality of the UE, an angular velocity of the UE, or a combination thereof.

5. The UE of claim 1, wherein the one or more processors are individually or collectively further operable to execute the code to cause the UE to:
measure a received strength of a first plurality of synchronization signal blocks associated with the plurality of transmit beams for generation of a first measurement database at a first synchronization signal burst set instance, wherein reception of the first plurality of synchronization signal blocks is associated with one of a plurality of synchronization signal burst set instances; and
generate a first plurality of spatial feature maps associated with the plurality of candidate receive beams in accordance with the first measurement database, the perception information, and a first plurality of predicted images generated for the first synchronization signal burst set instance.

6. The UE of claim 5, wherein each spatial feature map of the first plurality of spatial feature maps is a mapping of predicted beam strength values for each of the plurality of candidate receive beams for spatial points associated with a spatial environment of the UE.

7. The UE of claim 5, wherein the one or more processors are individually or collectively further operable to execute the code to cause the UE to:
generate a second plurality of spatial feature maps associated with the plurality of candidate receive beams in accordance with the first measurement database, the perception information, a first plurality of predicted camera images, and a second plurality of predicted camera images associated with the expected environment of the UE at a future synchronization signal burst set instance; and
generate a combined spatial feature map in accordance with the first plurality of spatial feature maps and the second plurality of spatial feature maps, the combined spatial feature map corresponding to the expected environment of the UE and resulting changes in predicted beam strength values for the plurality of candidate receive beams.

8. The UE of claim 1, wherein the one or more processors are individually or collectively further operable to execute the code to cause the UE to:
transmit, to the network entity, a UE status indication that comprises one or more of a spatial target area, a velocity of the UE, a memory and computational capacity of a computer of the UE, and capability information associated with the one or more sensors.

9. The UE of claim 1, wherein the one or more processors are individually or collectively further operable to execute the code to cause the UE to:
receive, from the network entity, a network entity status indication and one or more operational parameters, the network entity status indication comprising an indication of a quantity of synchronization signal blocks associated with the plurality of transmit beams and a periodicity of a synchronization signal burst set, the one or more operational parameters comprising one or more of sensor settings for the one or more sensors associated with the UE and one or more parameters for one or more algorithms at the UE.

10. The UE of claim 9, wherein the one or more processors are individually or collectively further operable to execute the code to cause the UE to:
transmit, to the network entity in accordance with receiving a first indication to transmit an experience replay, the first indication comprised in the network entity status indication or in the one or more operational parameters, the experience replay comprising one or more portions of information used by the UE in the selection of the receive beam for each transmit beam of the plurality of transmit beams, the one or more portions of information comprising one or more of the perception information, a status of the expected environment, one or more algorithmic outputs of the one or more algorithms designated for beam management using the perception information, or a combination thereof.

11. The UE of claim 1, wherein the selection, in accordance with the perception information, of the receive beam for measuring the strength of reference signal of each transmit beam of the plurality of transmit beams is in accordance with a machine learning algorithm or a non-machine learning algorithm.

12. The UE of claim 1, wherein the one or more processors are individually or collectively further operable to execute the code to cause the UE to:
transmit, to the network entity, a request to initialize perception-assisted beam management; and
receive an acknowledgment message in response to the request, selecting the receive beam for each transmit beam in accordance with the perception information is in accordance with receiving the acknowledgment message.

13. The UE of claim 1, wherein the UE is a vehicular UE (vUE).

14. A method for wireless communications at a user equipment (UE), comprising:
obtaining a plurality of transmit beams associated with a network entity, wherein a plurality of candidate receive beams associated with the UE correspond to the plurality of transmit beams;
obtaining, from one or more sensors associated with the UE, perception information indicative of an expected environment of the UE, wherein the perception information comprises mobility information, spatial information, and additional information associated with the UE;
selecting, in accordance with the perception information and the expected environment of the UE, a receive beam from the plurality of candidate receive beams to measure a strength of reference signals transmitted by each transmit beam of the plurality of transmit beams; and
receiving one or more reference signals and related signals from the plurality of transmit beams via one or more of the selected receive beams.

15. The method of claim 14, further comprising:
obtaining, over one or more durations, one or more camera images associated with a plurality of camera imaging instances and one or more inertial measurement unit (IMU) logs associated with a plurality of IMU logging instances, the perception information comprising the one or more camera images and the one or more IMU logs.

16. The method of claim 15, further comprising:
generating one or more pluralities of predicted camera images indicative of the expected environment of the UE in accordance with the one or more camera images and the one or more IMU logs.

17. The method of claim 15, wherein:
each camera image of the one or more camera images comprises a depth map and a color model associated with a spatial environment of the UE; and
each IMU log of the one or more IMU logs comprises inertial information of the UE relative to the spatial environment of the UE, the inertial information comprising one or more of a speed of the UE, spatial directionality of the UE, an angular velocity of the UE, or a combination thereof.

18. The method of claim 14, further comprising:
measuring a received strength of a first plurality of synchronization signal blocks associated with the plurality of transmit beams for generation of a first measurement database at a first synchronization signal burst set instance, wherein reception of the first plurality of synchronization signal blocks is associated with one of a plurality of synchronization signal burst set instances; and
generating a first plurality of spatial feature maps associated with the plurality of candidate receive beams in accordance with the first measurement database, the perception information, and a first plurality of predicted images generated for the first synchronization signal burst set instance.

19. The method of claim 18, wherein each spatial feature map of the first plurality of spatial feature maps is a mapping of predicted beam strength values for each of the plurality of candidate receive beams for spatial points associated with a spatial environment of the UE.

20. A user equipment (UE) for wireless communications, comprising:
means for obtaining a plurality of transmit beams associated with a network entity, wherein a plurality of candidate receive beams associated with the UE correspond to the plurality of transmit beams;
means for obtaining, from one or more sensors associated with the UE, perception information indicative of an expected environment of the UE, wherein the perception information comprises mobility information, spatial information, and additional information associated with the UE;
means for selecting, in accordance with the perception information and the expected environment of the UE, a receive beam from the plurality of candidate receive beams to measure a strength of reference signals transmitted by each transmit beam of the plurality of transmit beams; and
means for receiving one or more reference signals and related signals from the plurality of transmit beams via one or more of the selected receive beams.
